(19) United States
(12) Patent Application Publication
(10) Pub. No.: US 2005/0083697 A1
(43) Pub. Date: Apr. 21, 2005

(54) Smart shadowless illumination system

(76) Inventor: Zoltan Filep, Turlock, CA (US)

Correspondence Address: ZOLTAN FILEP, 300 WILEY CT., TURLOCK, CA, 95380, US

(21) Appl. No.: 10/969,455

(22) Filed: Oct. 20, 2004

Related U.S. Application Data
(60) Provisional application No. 60/512,705, filed on Oct. 21, 2003.

(51) Int. Cl. F21V 1/00

(52) U.S. Cl. 362/285

(57) ABSTRACT

What is new in this invention, it is the complete automation of the light assembly positioning or selection. Using sensors and robotics, human intervention became completely unnecessary. Once the system installed and optimized, human intervention is unnecessary and the system is working independently. The system is sensing the possibility of appearance of shadow for a well-determined area and it is taking measures to avoid it.

### REFERENCES CITED U.S. PATENT DOCUMENTS

| | | | |
|---|---|---|---|
| 3,702,928 | November 1972 | Alger | 362/233 X |
| 4,025,778 | May 1977 | Hayakawa | 240/1.4 |
| 4,078,720 | March 1978 | Nurnberg | 236/46 R |
| 4,200,862 | April 1980 | Campbell et al. | 340/825.07 X |
| 4,288,844 | September 1981 | Fishet et al. | 362/804 X |
| 4,365,720 | December 1982 | Kaneshiro | 211/87 |
| 4,578,575 | March 1986 | Roos | 250/203 |
| 4,639,838 | January 1987 | Kato et al. | 362/33 |
| 4,709,412 | November 1987 | Seymour et al. | 455/128 |
| 4,712,167 | December 1987 | Gordin et al. | 362/233 |
| 4,728,949 | March 1988 | Platto et al. | 340/825.37 |
| 4,817,203 | March 1989 | Tsurumoto et al. | 455/603 |
| 4,826,059 | May 1989 | Bosch et al. | 211/DIG. 1 |
| 4,890,207 | December 1989 | Jones | 362/233 |
| 5,010,459 | April 1991 | Taylor et al. | 362/233 X |
| 5,031,082 | July 1991 | Bierend | 362/233 X |
| 5,038,261 | August 1991 | Kloos | 362/286 |
| 5,060,124 | October 1991 | Crispin et al. | 362/804 X |
| 5,068,767 | November 1991 | Koyama | 362/33 |
| 5,072,216 | December 1991 | Grange | 362/233 X |
| 5,093,769 | March 1992 | Luntsford | 362/804 X |
| 5,189,412 | February 1993 | Mehta et al. | 340/825 |
| 5,294,915 | March 1994 | Owen | 340/539 |
| 5,526,245 | June 1996 | Davis et al. | 362/233 |

### FOREIGN PATENT DOCUMENTS

| | | |
|---|---|---|
| 2449994 | September 1980 | France |
| 0014536 | January 1985 | Japan |

### BACKGROUND OF THE INVENTION

Shadowless lighting systems are used in medical procedure rooms, dental offices, labs, clean-rooms and many other areas. In all these applications it is required a local illumination of a certain, geometrically well-defined, area.

Prior arts are either a single- or a multiple-light assembly, controlled by different type of controls. These controls need human intervention, what is not always available. The invention is suitable to both of the assembly types, single or multiple lights, making human intervention unnecessary.

### SUMMARY OF THE INVENTION

The invention is directed to eliminate human intervention in shadowless illumination systems and to create optimal lighting conditions.

For a better understanding of the working principles of the invention, it is better to analyze first the purpose of the invention.

The primary purpose of the invention is to illuminate a defined/target area, without having a disturbing shadow over this specific area.

Shadow, thru definition, means usually a less illuminated area bordered by a more illuminated area. It is the most disturbing, when the less illuminated area is in the primary visual field—which is the work area too—, and the more illuminated area is in the secondary visual field. The optimal situation is when the primary visual field is better illuminated than the secondary visual field.

Shadow is created usually, when between the light source and the target area interposes an object. This object can be the head of a surgeon or dentist, and cannot be controlled in his moves, neither restricted, due the importance of their activity. So, it is necessary for the system to react to different situations, for self-corrections, to be smart.

To eliminate shadow in a certain target position, as analyzed above, it is necessary to make sure, that the primary visual field—the target area—is better illuminated than the secondary visual field—the unimportant area.

To achieve this, there are 2 solutions:
1. Dynamic—to move the lamp, so there is no obstacle between the light-source and the target.
2. Static—to turn off the lamp what is actively creating the shadow on the target area.

For single-lamp systems it applies the first solution.

For multiple-lamp systems there apply both solutions.

The invention's purpose is also to eliminate human intervention in adjustments.

For a system to be able to react, it needs some inputs. The inputs in the invention are the direct visual contact conditions from the lamp(s) to the target area, information resulted from targeting the object of illumination.

For this, there are 2 different procedures:
1. Direct targeting, where an emitter (infrared, laser, etc.) is placed directly on the target or in the very close vicinity of the target and each lamp has his own receiver(s)/sensor(s) used for validations.
2. Indirect targeting, where the illumination area is targeted with a laser-beam, or any other information vector, coded or un-coded. The sensors from the lamps are reading that information and the control logic is processing it.

The following examples will use a direct targeting procedure. If direct targeting cannot be used because of different reasons, indirect targeting will be used. That makes the system more expensive, but still possible.

The number of motion axis and of features determines the number of receivers on each lamp.

Other component to be determined in the invention is the optimal geometry.

For a minimal configuration, because of cost and reliability reasons, it is necessary to keep all the time the lamp(s) perpendicularly oriented towards the same spot and to keep the same distance to the target area. That makes additional tilt and focusing mechanism unnecessary.

The theoretical geometrical area equidistantly defined to a single point is a sphere. In this case, the minimal, is a circle or an arch of a circle, with the target as center. Any mechanism, once mounted and oriented towards the center, if it is moved along that circular trajectory is keeping his orientation and distance to that center point.

So, for the most efficient configuration, the rail will have a circular geometry.

Instead the use of a rail, it is also possible the use of a rotating arm for dynamic applications.

### BRIEF DESCRIPTION OF THE INVENTION

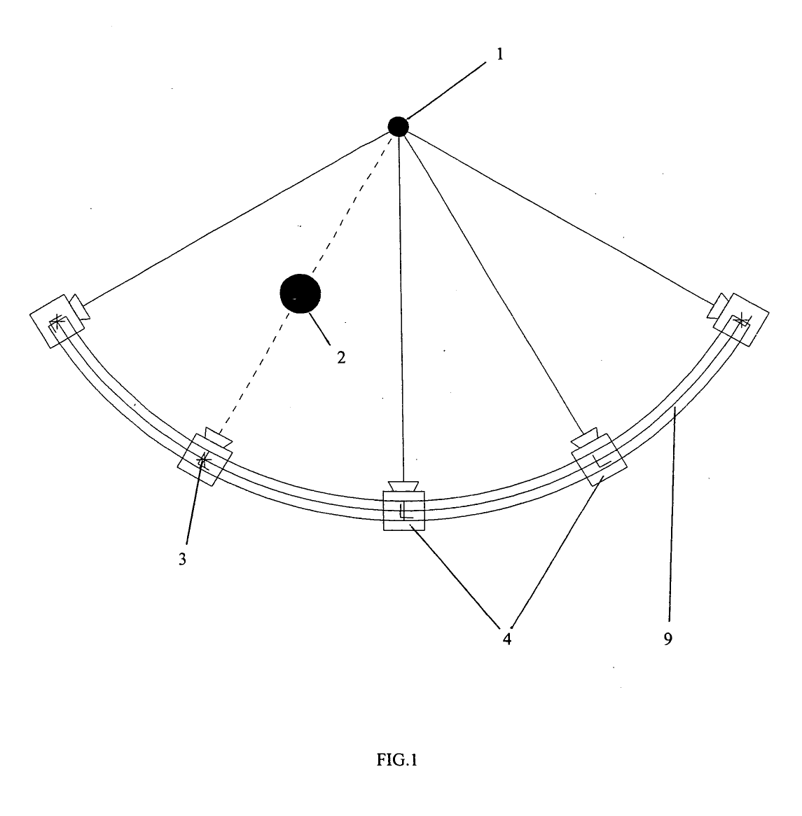

An example solution for the static shadowless illumination system is presented in FIG. 1 to FIG. 4.

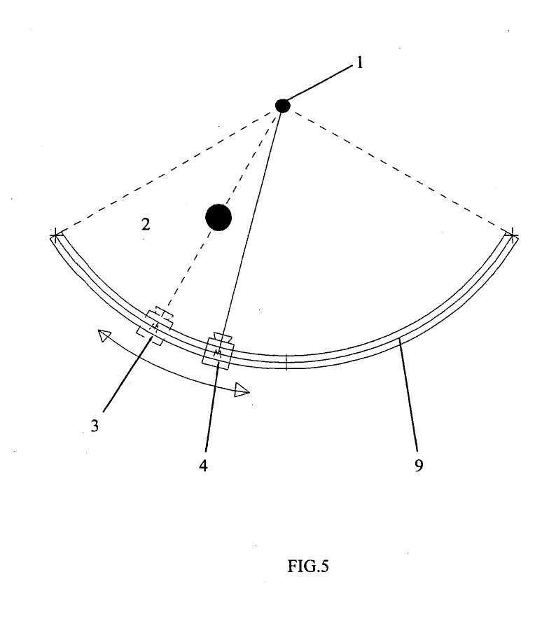

An example solution for the dynamic shadowless illumination system is represented in FIG. 5 to FIG. 8.

FIG. 1 is a general view of a static multiple-lamp system.

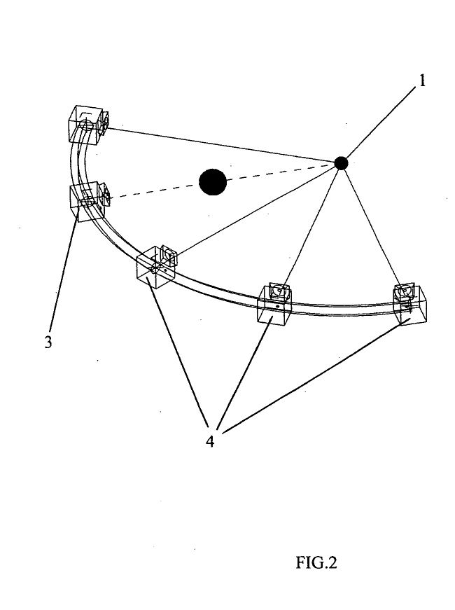

FIG. 2 is a general view of a static multiple-lamp system.

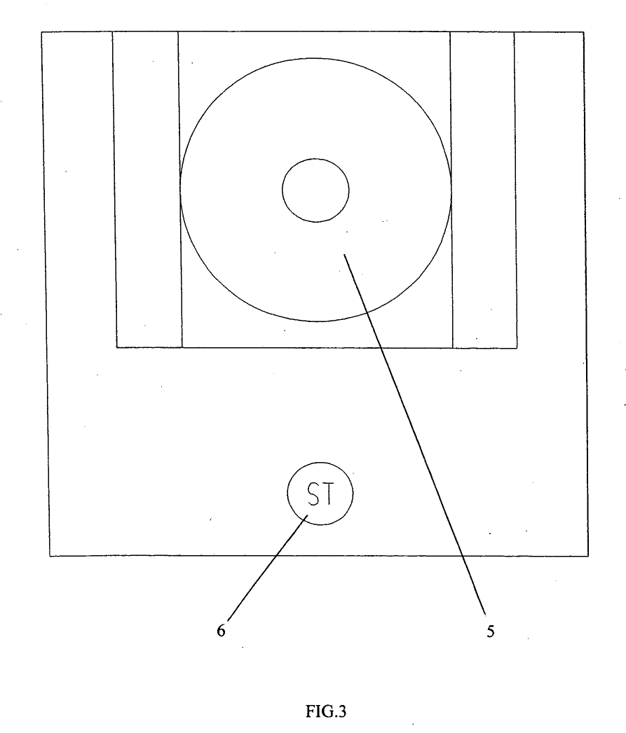

FIG. 3 is a front view of the light-assembly of a static multiple-lamp system.

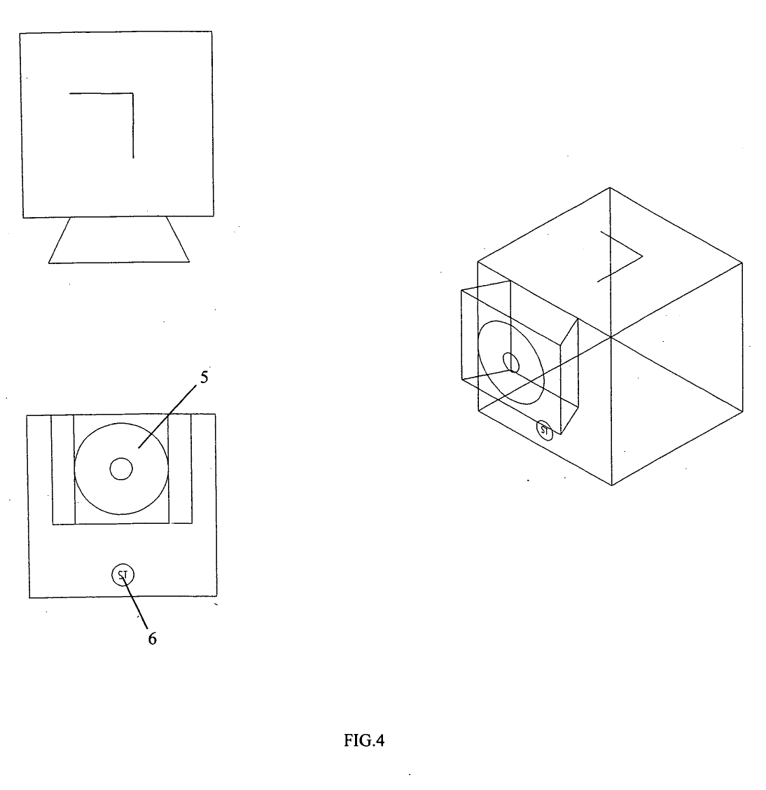

FIG. 4 is a general view of the light-assembly of a static multiple-lamp system.

FIG. 5 is a general view of a dynamic single-lamp system.

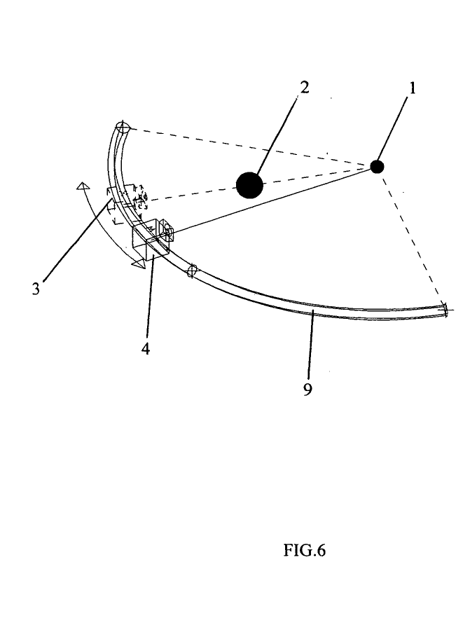

FIG. 6 is a general view of a dynamic single-lamp system.

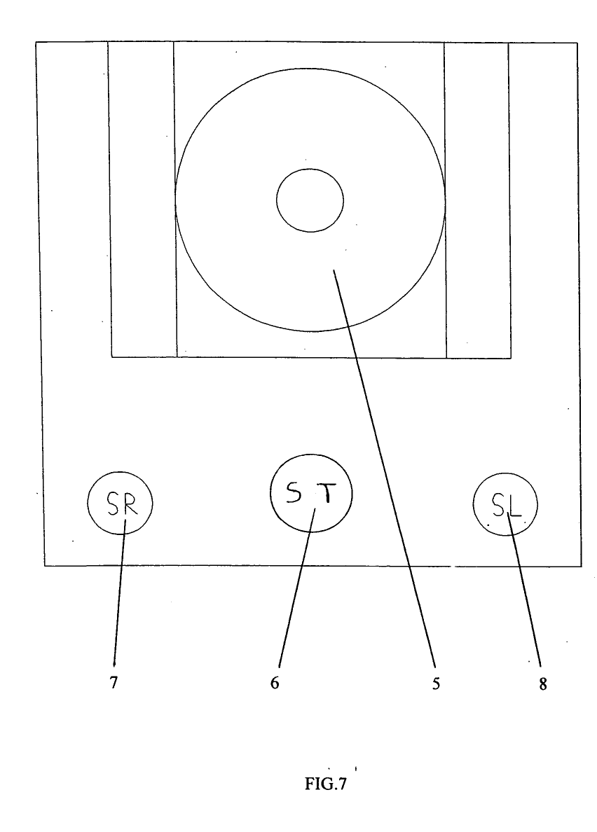

FIG. 7 is a front view of the light-assembly of a dynamic single-lamp system.

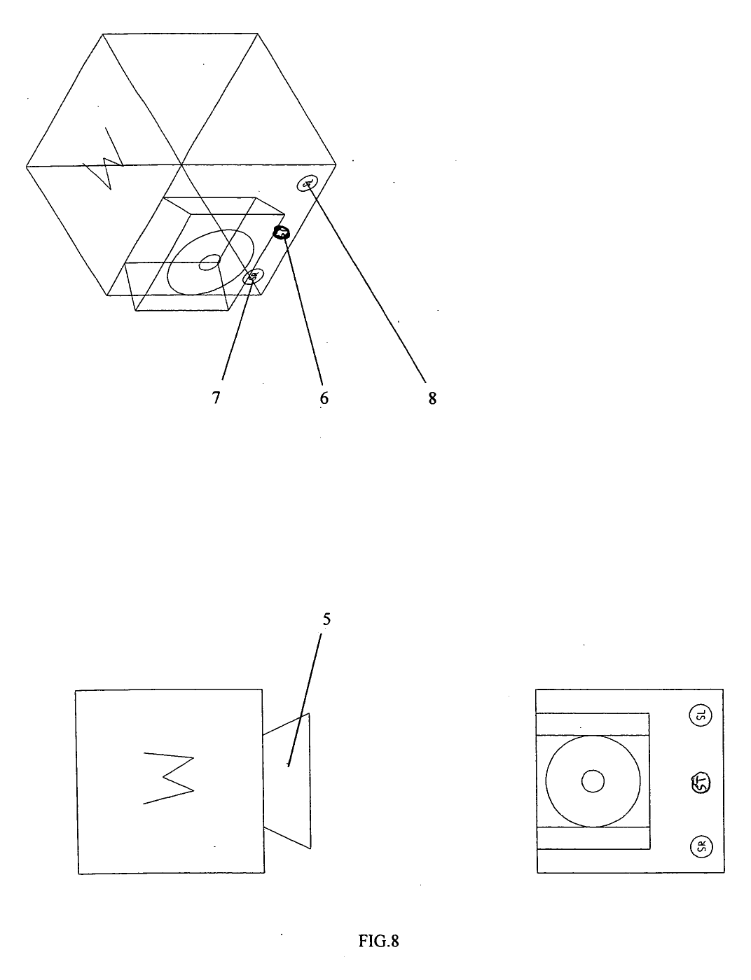

FIG. 8 is a general view of the light-assembly of a dynamic single-lamp system.

### DETAILED DESCRIPTION OF THE INVENTION

In all drawings:
1—emitter target area/work zone
2—obstacle, shadow creating object
3—invalid light/position
4—valid light/position
5—light/lamp
6—validation sensor light
7—direction sensor right
8—direction sensor left
9—rail.

The static solution for the shadowless illumination system is represented in FIG. 1, FIG. 2, FIG. 3 and FIG. 4.

The target area can be marked directly or indirectly. The emitter 1 is used to mark directly the target area. The obstacle 2 is blocking the visibility for lamp 3, the fact is sensed by the sensor 6, what is turning the lamp 5 off. The other lamps, in position 4 have a visibility on 1, so they are on.

The lamps are mounted on the rail 9 and they are oriented and focused on 1.

The dynamic solution for the shadowless illumination system, with a single-axis motion control, is showed in FIG. 5, FIG. 6, FIG. 7 and FIG. 8.

The target area can be marked directly or indirectly. The emitter 1 is used to mark directly the target area. The obstacle 2 is blocking the visibility for lamp 3, the fact is sensed by the sensor 6, 7 and 8. The sensors, together with an internal control logic, are controlling a bi-directional motor mounted inside the lamp's housing. This motor is moving the lamp along the rail in such a manner, that the lamp is moved out from the shadow zone. The sensors 6, 7 and 8 are determining the sense of motion. The optimal position for a single-lamp system is out of the shadow zone, but still as close as possible to the operator's head.

Implementing a positive logic on sensor 8 and a negative logic on sensor 6 and 7, the lamp assembly will be situated all the time in the very close proximity of the shadow zone, actively following it. It is recommended the use of limit switches at the ends of the rail, if it is not fully circular.

The examples above are describing technical solutions using direct targeting. If direct targeting is not possible, indirect targeting will be used.

The systems described above are not strictly defined, they are just examples.

There are multiple solutions for the same purpose, not all have been presented.

It should be understood that the invention is not intended to be limited by the specifics of the above described embodiments, but rather defined by the operating principles.

1. A room lighting system for shadowless illumination comprising:
a targeted illumination area in a room;
a rail/arm assembly mounted in a room;
a singular light assembly or a plurality of light assemblies mounted on said rail;
a control system to control said light assemblies.

2. A lighting system according to claim 1 wherein:
said targeted illumination area is marked directly with an emitter installed in close proximity; or
said targeted illumination area is marked indirectly with a reflected coded or un-coded information vector.

3. A lighting system according to claim 1 wherein:
said rail/arm assembly is equidistant to said targeted illumination area as center.

4. A lighting system according to claim 1 wherein:
said plurality of light assemblies are mounted rigidly on said rail all being directed towards and focused on said targeted illumination area.

5. A lighting system according to claim 1 wherein:
said singular light assembly is mounted on a carriage rolling on said rail being directed towards and focused on said targeted illumination area.

6. A lighting system according to claim 1 wherein:
said control system is controlling a plurality of light assemblies by switching them ‘ON’ and ‘OFF’; or
said control system is controlling the motion of said singular light assembly with said carriage on said rail maintaining direct view to said targeted illumination area.

7. A lighting system according to claim 1 wherein:
said control system includes a plurality of input devices as receivers/sensors tuned to and receiving signal from said emitter or said reflected information vector.

8. A lighting system according to claim 1 wherein:
said control system also includes a controller logic with program for command and control.

9. A lighting system according to claim 1 wherein:
said control system also includes output devices as servo-mechanism and motor for motion control of said carriage or switching devices for switching said plurality of light assemblies ‘ON’ and ‘OFF’ independently.

10. A lighting system according to claim 1 wherein:
said control system's program using said input devices' input is determining the direction and distance of motion of said carriage with said singular light assembly; or
said control system's program using said input devices' input is selecting which of said plurality of light assemblies is switched ‘OFF’.
